(19) United States
(12) Patent Application Publication
(10) Pub. No.: US 2022/0001692 A1
(43) Pub. Date: Jan. 6, 2022

(54) VARIABLE CENTER CAP WHEEL

(71) Applicant: Wheelimage Corp., Brea, CA (US)

(72) Inventor: David Batarseh, Brea, CA (US)

(21) Appl. No.: 17/447,860

(22) Filed: Sep. 16, 2021

(51) Int. Cl. B60B 7/00; B60B 7/06; B60B 7/14; B60B 7/10

(52) U.S. Cl. CPC B60B 7/0013; B60B 7/10; B60B 7/14; B60B 7/066

(57) ABSTRACT

A wheel having a hub portion disposed in a center of the wheel, a center bore disposed at the center of the wheel and disposed within a perimeter of the hub portion, a center bore perimeter wall disposed around a perimeter of the center bore and a center bore profile nested within the center bore perimeter wall, the center bore profile having a snap cap engaging element configured to secure a snap cap and a CR adapter thread configured to engage with a lower thread of a CR adapter, and a CR adapter configured to attach a hex cap to the CR adapter thread. A lug cover may also be secured to the hex cap. The center bore profile allows for the selective utilization of either an ESR snap cap or a hex cap as part of a wheel, based upon application needs or aesthetic preference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

### 1. Field of the Invention

The invention relates generally to wheels and specifically to wheels configured to receive different types of wheel center cap.

### 2. Description of the Related Art

Within the automotive industry, wheel center caps designed to attach to wheels may be used to both protect central wheel elements and help achieve a desired visual aesthetic. Multiple types of wheel center caps may be available for purchase, including snap caps that are configured to pressure fit to a wheel and hex caps that are configured to engage with a wheel using threads. However, automotive wheels present in the industry are only configured to accept one of the types of wheel center cap available. This effectively limits the type of wheel center caps a consumer can use based upon the wheel they purchase. This may be undesirable in instances in which a consumer may not want to use the type of wheel center cap that a particular wheel is configured for, or if the consumer already owns wheel center caps that are incompatible with their current wheels.

Therefore, there is a need to solve the problems described above by providing a wheel capable of using either type of available wheel center cap.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a wheel is provided, the wheel comprising: a hub portion of the wheel, the hub portion disposed in a center of the wheel; a center bore disposed at the center of the wheel and disposed within a perimeter of the hub portion; a center bore perimeter wall disposed around a perimeter of the center bore; a center bore profile nested within the center bore perimeter wall, the center bore profile comprising: a wheel threaded portion configured to engage with a lower thread of an adapter; and a snap cap engaging element configured to secure a snap cap, the snap cap engaging element comprising a seating groove, a securing ridge disposed below the seating groove and a clip slot disposed below the securing ridge; an adapter comprising: an upper thread; a lower thread configured to engage with the wheel threaded portion; and a seating edge disposed between the upper thread and the lower thread, wherein the seating edge is configured to fit securely within the seating groove upon engagement of the lower thread with the wheel threaded portion; and a hex cap comprising: a hex cap body; a snap cap slot disposed within the hex cap body; a hex snap securing ridge disposed within the snap cap slot; and a hex cap thread disposed within the hex cap body, the hex cap thread being configured to engage with the upper thread of the adapter. One advantage is that either a snap cap or a hex cap may be attached to center bore profile, based on the need or preference of the user, through selective usage of the adapter. Another advantage is that a user that already owns a particular set of wheel center caps, whether they are snap caps or hex caps, may use either of them with the wheel. Another advantage is a lug cover may be secured to the wheel through the utilization of gaskets held in gasket retainer slots disposed within the hex cap body and a lug cover seat on the wheel in order to seal and protect the hub portion of the wheel. Another advantage is that the wheel threaded portion and the snap cap engaging element are both nested within the center bore, providing a singular location in which either type of wheel center cap may be secured, enhancing ease of use.

In another aspect, a wheel is provided, the wheel comprising: a hub portion of the wheel, the hub portion disposed in a center of the wheel; a center bore disposed at the center of the wheel and disposed within a perimeter of the hub portion; a center bore perimeter wall disposed around a perimeter of the center bore; a center bore profile nested within the center bore perimeter wall, the center bore profile comprising: a wheel threaded portion configured to engage with a lower thread of an adapter; a snap cap engaging element configured to secure a snap cap, the snap cap engaging element comprising a seating groove, a securing ridge disposed below the seating groove and a clip slot disposed below the securing ridge; and an adapter comprising: an upper thread; a lower thread configured to engage with the wheel threaded portion; and a seating edge disposed between the upper thread and the lower thread, wherein the seating edge is configured to fit securely within the seating groove upon engagement of the lower thread with the wheel threaded portion. Again, an advantage is that either a snap cap or a hex cap may be attached to center bore profile, based on the need or preference of the user, through selective usage of the adapter. Another advantage is that a user that already owns a particular set of wheel center caps, whether they are snap caps or hex caps, may use either of them with the wheel. Another advantage is that the wheel threaded portion and the snap cap engaging element are both nested within the center bore, providing a singular location in which either type of wheel center cap may be secured, enhancing ease of use.

In another aspect, a wheel is provided, the wheel comprising: a hub portion of the wheel, the hub portion disposed in a center of the wheel; a center bore disposed at the center of the wheel and disposed within a perimeter of the hub portion; a center bore perimeter wall disposed around a perimeter of the center bore; and a center bore profile nested within the center bore perimeter wall, the center bore profile comprising: a wheel threaded portion configured to engage with a lower thread of an adapter; and a snap cap engaging element configured to secure a snap cap, the snap cap engaging element comprising a seating groove, a securing ridge disposed below the seating groove and a clip slot disposed below the securing ridge. Again, an advantage is that either a snap cap or a hex cap may be attached to center bore profile, based on the need or preference of the user, through selective usage of the adapter. Another advantage is that a user that already owns a particular set of wheel center caps, whether they are snap caps or hex caps, may use either of them with the wheel. Another advantage is that the wheel threaded portion and the snap cap engaging element are both nested within the center bore, providing a singular location in which either type of wheel center cap may be secured, enhancing ease of use.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1A illustrates the top perspective view of a wheel having a CR hex cap installed, according to an aspect.

FIG. 1B illustrates an exploded view of a wheel having a CR hex cap installed, according to an aspect.

FIG. 2A illustrates the top perspective view of a wheel having an ESR snap cap installed, according to an aspect.

FIG. 2B illustrates the top perspective view of a wheel having an ESR snap cap, according to an aspect.

FIG. 3A illustrates the cross-sectional exploded view of CR hex cap above a wheel, according to an aspect.

FIG. 3B illustrates the cross-sectional side view of CR hex cap installed within a wheel, according to an aspect.

FIG. 4 illustrates the exploded view of CR hex cap having an acrylic ESR hex snap cap, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

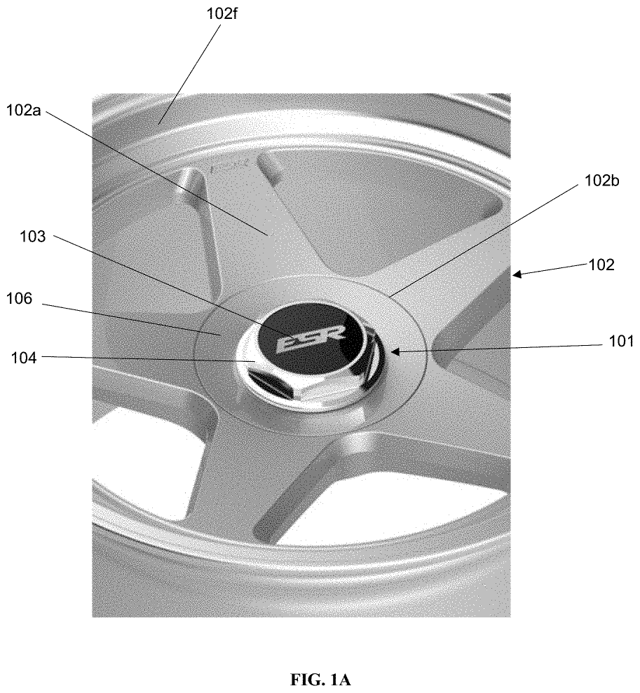

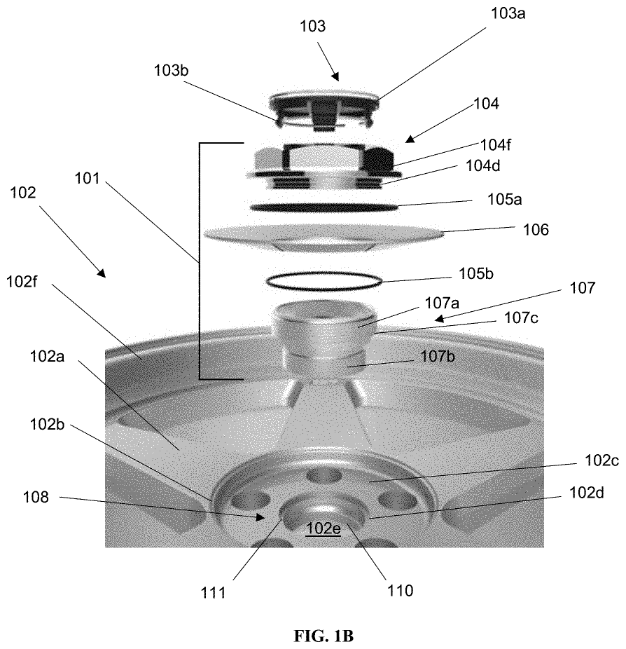

FIG. 1A illustrates the top perspective view of a wheel 102 having a CR hex cap 101, according to an aspect. FIG. 1B illustrates an exploded view of a wheel 102 having a CR hex cap 101, according to an aspect. The herein disclosed wheel 102 may be configured to hold different types of wheel center caps, including a hex cap 104 and an ESR snap cap (not shown), with the former being held through usage of an adapter or CR adapter 107 as part of a CR hex cap 101. The wheel 102 of FIG. 1A-1B may be comprised of a hub portion 102c that is disposed at the center of the wheel 102, a center bore 102e disposed at the center of the wheel 102 and disposed within a perimeter of the hub portion 102c, a center bore perimeter wall 102d disposed around a perimeter of the center bore 102e; and a center bore profile 108 nested within the center bore perimeter wall 102d. In an example, the center bore profile 108 may be nested within the center bore perimeter wall 102d by having said center bore profile 108 machined into the center bore perimeter wall 102d itself. In another example, the center bore profile 108 may be nested within the center bore perimeter wall by attaching a separate, unified center bore profile 108 structure to the center bore perimeter wall 102d, such that the center bore profile 108 is disposed within the center bore 102e. The center bore profile 108 may be comprised of a CR adapter thread 110 and a snap cap engaging element 111. The CR adapter thread 110 may also be referred to as wheel threaded portion and be configured to engage with a lower thread 107b of a CR adapter 107. The snap cap engaging element 111 may be positioned above the CR adapter thread 110 within the center bore 102e, with the snap cap engaging element 111 being comprised of a seating groove (not shown) positioned just below the hub portion 102c, a securing ridge (not shown) positioned below the seating groove and a clip slot (not shown) positioned below the securing ridge. The wheel, its hub portion 102c and the center bore 102e may be coaxially aligned, such that the hub portion 102c is positioned at the center of the wheel 102, and the center bore 102e is positioned at the center of the hub portion 102c. It should be understood that the wheel may be comprised of additional structural elements to facilitate its usage in automotive applications. In an example, the wheel may be further comprised of a lug cover seat 102b positioned on an outside perimeter of the hub portion 102c, wheel spokes 102a positioned on an outside perimeter of the lug cover seat 102b, and a wheel rim 102f positioned on an outside perimeter of the wheel spokes, wherein the wheel rim 102f, wheel spokes 102a, lug cover seat 102b and hub portion 102c are machined as a singular, monolithic wheel structure. Variations of said structural elements of the wheel may be utilized, as long as the desired attachment to different types of wheel center cap to the wheel is still possible as described hereinbelow.

The CR hex cap 101 may be comprised of a hex cap 104, the hex cap 104 having a hex cap body 104f, a snap cap slot (not shown) disposed within the hex cap body, a hex snap securing ridge (not shown) disposed within the snap cap slot, two upper gasket retainer slots (not shown) disposed within the hex cap body 104f, a lower gasket retainer slot 104d disposed within the hex cap body 104f and below the upper gasket retainer slots, and a hex cap thread (not shown) on the hex cap body 104f disposed below the lower gasket retainer slot wherein the snap cap slot and hex snap securing ridge are configured to secure an ESR hex snap cap 103. The CR hex cap may be further comprised of two upper gaskets 105a, wherein each upper gasket 105a is configured to be held in a different upper gasket retainer slot, a lug cover 106 disposed around the hex cap body 104f and below the upper gaskets 105a, a lower gasket 105b configured to be held in the lower gasket retainer slot 104d below the lug cover 106, such that the lug cover 106 is secured between the upper gaskets 105a and the lower gasket 105b, a CR adapter 107 having an upper thread 107a configured to engage with the hex cap thread of the above hex cap 104, a lower thread 107b configured to engage with the a CR adapter thread (not shown) on the center bore profile 108 and a seating edge 107c disposed between the upper thread 107a and the lower thread 107b. The hex cap thread may be internally disposed within the hex cap 104, to provide a threaded female coupling that is configured to engage with a threaded male coupling provided by the upper thread 107a of the CR adapter 107. The CR adapter 107 may also be referred to simply as an adapter. The upper gasket retainer slots are configured such that they are concentric, and that each upper gasket retainer slot has a different diameter. The upper gaskets 105a and lower gasket 105b are configured to secure the lug cover 106 to the CR hex cap 101 by having said gaskets compressed against the upper and lower surfaces of the lug cover 106 respectively as a result of the placement of each gasket within its respective retainer slot on the hex cap 104.

Upon engagement of the CR hex cap 101 with the CR adapter thread 110, the lug cover 106 may be secured into the lug cover seat 102b and the seating edge 107c of the CR adapter 107 may be secured within the seating groove of the snap cap engaging element 108, helping to keep the formed wheel 102 together. The lug cover 106 may be supported by the lug cover seat 102b and the lower gasket from below, and the two upper gaskets 105a from above, providing a secure fitting of the lug cover 106 to the wheel 102. Different types of snap caps may be implemented on the wheel 102, depending on which type of wheel center cap is implemented. When using the CR hex cap 101, an ESR hex snap cap 103 may be attached to the wheel through insertion into the snap cap slot of the hex cap 104. Alternatively, an ESR snap cap (not shown) may be inserted directly into the center bore profile 108, without using the CR hex cap 101. The ESR hex snap cap 103 may be comprised of a hex snap body 103a attached to one or more hex snap clips 103b. The ESR snap cap may be comprised of a snap cap body (not shown) attached to one or more snap cap clips. The ESR hex snap cap 103 and the ESR snap cap, may be made of an appropriate material, such as metal or acrylic, and have a design and/or logo provided on them, such that the design and/or logo is visible when the snap cap is installed on a wheel 102. The structural components of the CR hex cap 101, such as the hex cap 104, lug cover 106 and CR adapter 107, may be composed of a suitable material to achieve the desired strength, durability and aesthetic, such as metal or plastic. The upper gaskets 105a and lower gasket 105b may be made of a material that helps to secure the lug cover 106 to the hex cap 104, such as rubber or silicone. The wheel 102 may be made of the same materials as other wheels common in the industry, including metals, rubbers and plastics. Both the ESR snap cap and the CR hex cap 101 with an attached ESR hex snap cap may be provided as part of a wheel 102 in order to protect wheel elements located within the wheel center bore 102e, as well as achieve the desired aesthetic for the wheel.

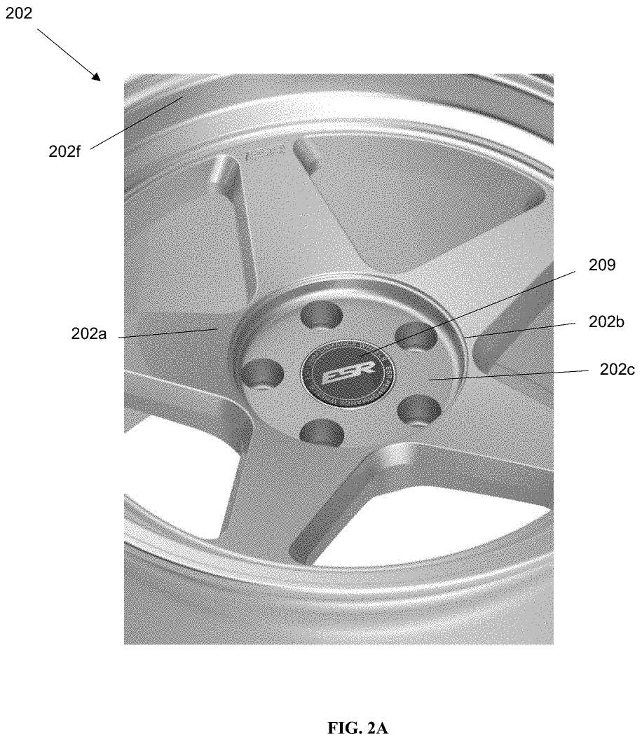

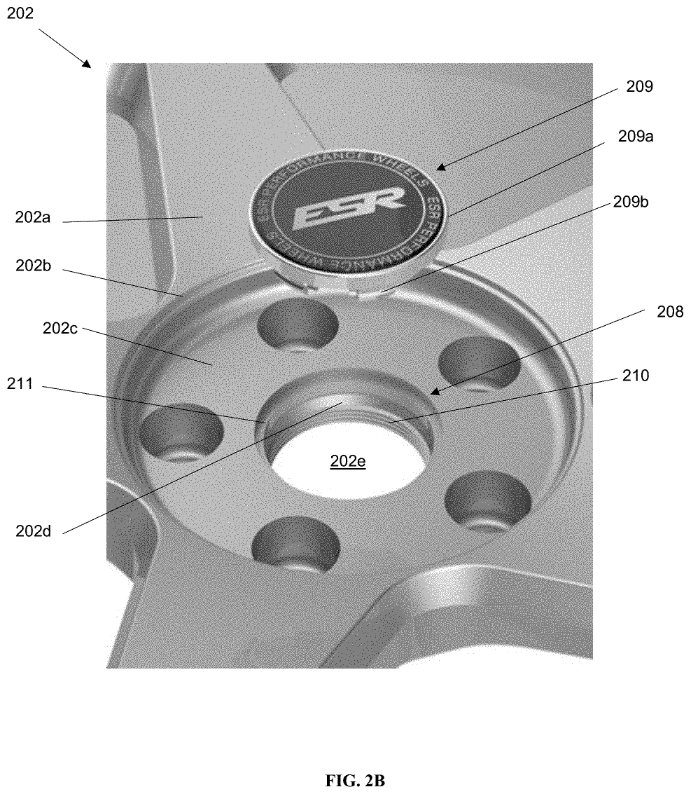

FIG. 2A illustrates the top perspective view of a wheel 202 having an ESR snap cap 209 installed, according to an aspect. FIG. 2B illustrates the top perspective view of a wheel 202 having an ESR snap cap 209, according to an aspect. The center bore profile 208 nested within the center bore perimeter wall 202d of the wheel 202 may be configured to hold either a CR hex cap (not shown) as described within FIG. 1A-1B, or an ESR snap cap 209. An ESR snap cap 209 may be comprised of a snap cap body 209a and one or more snap cap clips 209b attached to the snap cap body 209a. The ESR snap cap 209 may be secured to the snap cap engaging element 211 through insertion of the snap cap clips 209b through the securing ridge (not shown), followed by expansion of the attached snap cap clips 209b into the clip slot (not shown) and the seating of the snap cap body within the seating groove (not shown). Unlike wheel 102 from FIG. 1A-1B that utilizes a hex cap 104 and ESR hex snap cap 103, ESR wheel 202 utilizes an ESR snap cap 209 that is pressure fit directly to the ESR wheel 202 itself. As a result of this, a CR hex cap is not needed when using a ESR snap cap 209 as a wheel center cap. Due to the presence of both a CR adapter thread and a snap cap engaging element in the center bore profile 208, a consumer may vary which type of wheel center cap they use based on their preference.

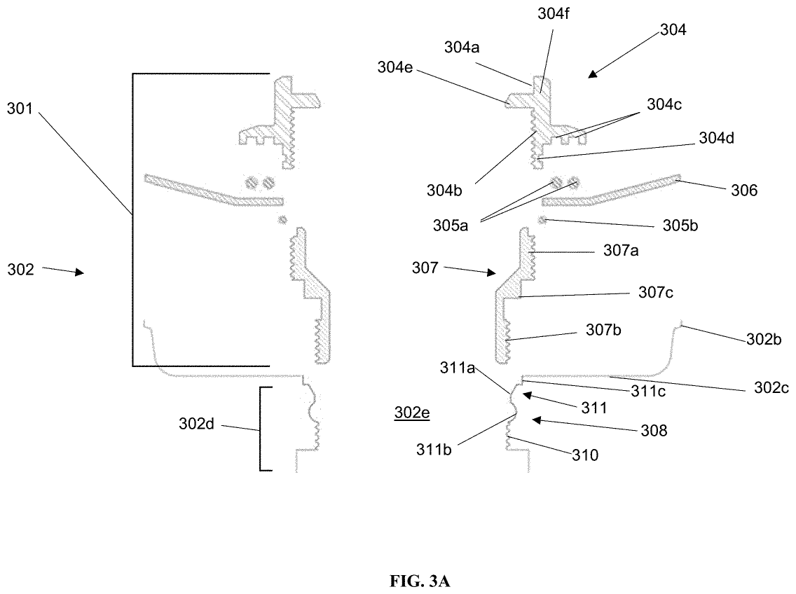

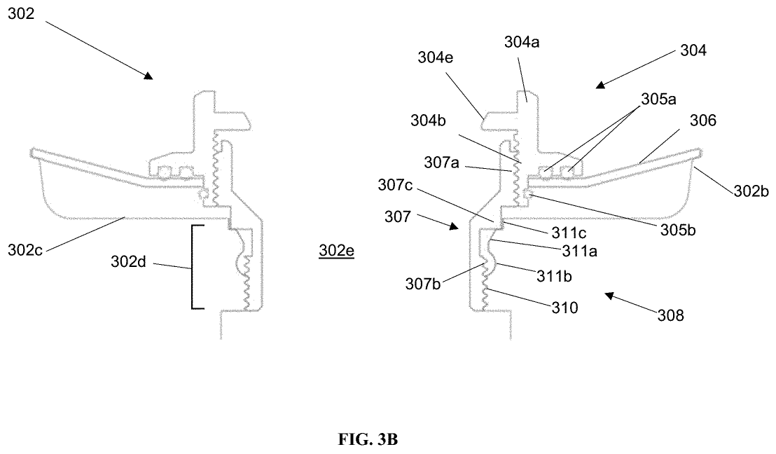

FIG. 3A illustrates the cross-sectional exploded view of CR hex cap 301 above a wheel 302, according to an aspect. FIG. 3B illustrates the cross-sectional side view of CR hex cap 301 installed on a wheel 302, according to an aspect. As described hereinabove, the center bore profile 308 may contain two unique elements that each allow for the usage of a different type of wheel center cap. These two unique elements are a snap cap engaging element 311 and a CR adapter thread 310. The snap cap engaging element 311 may be configured to securely hold a snap cap, such as the ESR snap cap 209 of FIG. 2A-2B, by providing a securing ridge 311a, clip slot 311b and seating groove 311c on the center bore profile 308 as described hereinabove. The CR adapter thread 310 may be configured to engage with the lower thread 307b of a CR adapter 307 to secure the CR hex cap 301 to the wheel 302. The hex cap 304 is configured to be secured to the CR adapter 307 through engagement of the hex cap thread 304b onto the upper thread 307a of the CR adapter 307. The snap cap slot 304a and a hex snap securing ridge 304e provided on the hex cap 304 may be configured to secure a hex snap cap, such as ESR hex snap cap 103 from FIG. 1A-1B, as part of the wheel 302. The attachment of an ESR hex snap cap to the hex cap 304 may also be done similarly to the attachment of the ESR snap cap to the snap cap engaging element 311 as described hereinabove. the ESR hex snap cap 103 may be comprised of a hex snap body 103a, with one or more attached hex snap clips 103b. Said hex snap clips 103b may be configured to be inserted within the hex snap securing ridge 304e, and then expanded outward once clearing said hex snap securing ridge 304e resulting in the seating the hex snap body 103a within the snap cap slot 304a, securing the ESR hex snap cap 103 to the hex cap 304.

The upper gasket retainer slots 304c and lower gasket retainer slot 304d may be used to hold the two upper gaskets 305a and the lower gasket 305b, respectively, in the proper location in order to allow for the lug cover 306 to be secured between said upper gaskets 305a and the lower gasket 305b, effectively attaching it to the CR hex cap 301. As can be seen from FIG. 3B, the securing of the CR hex cap 301 to the CR adapter thread 310 of the center bore profile 308 results in a secure seating of the lug cover 306 within the lug cover seat 302b of the wheel 302. The tension resulting from the seating of the lug cover 306 to the lug cover seat 302b of the wheel 302 helps to keep the CR hex cap 301 together, as well as effectively sealing the hub portion 302c of the wheel 302 This sealing of the hub portion 302c may be desirable to protect elements within the hub portion 302c from the effects of weather and general wear and tear. The center bore profile 308 provided in the herein disclosed ESR wheel 302 may be suitably implemented on different types of wheels in order to facilitate the usage of various types of wheel center caps, including the pressure-fit snap caps and threaded caps disclosed herein. The utilization of both a snap cap engaging element 311 and a CR adapter thread 310 on the same wheel 302 may allow for the installation of either a CR hex cap 301 or an ESR snap cap through nesting of either cap within the center bore 302e of the wheel 302 and subsequent engagement with the appropriate center bore profile 308 elements. Additionally, the inclusion of the CR adapter thread 310 disposed on the center bore perimeter wall 302d within the center bore 302e, when used in conjunction with the CR adapter 307, allows for the CR adapter thread 310 on the wheel 302 to be provided internally, removing the need for external threading that protrudes above the hub portion 302c. This in turn will allow for the external aesthetic of the wheel to not be limited by the needs of either type of wheel center cap.

As described previously, the snap cap engaging element 311 of the center bore profile 308 may be comprised of three main elements: a securing ridge 311a, a clip slot 311b and a seating groove 311c. A snap cap, such as ESR snap cap 209 from FIG. 2A-2B, may attach to the snap cap engaging element 311 as a result of the insertion of each attached snap cap clip 209b through the securing ridge 311a and following expansion of each snap cap clip 209b into the clip slot 311b, such that each snap cap clip 209b is secured in the clip slot 311b and the snap cap body 209a is secured within the seating groove 311c, as seen in FIG. 2B. This interaction of the snap cap with the snap cap engaging element allows for an ESR snap cap to be secured to the wheel 302. Certain elements of the snap cap engaging element 308 may interact with the CR hex cap 301 in order to facilitate a more secure seating of said CR hex cap 301 to the wheel 302 upon installation. The CR adapter 307 may be comprised of an upper thread 307a having a suitable diameter for threading into a hex cap 304, a lower thread 307b having a suitable diameter for threading into the CR adapter thread 310 of the center bore profile 308 and a seating edge 307c disposed between the two threads, with all three CR adapter elements provided as a singular unified piece. Upon engagement of the lower thread 307b of the CR adapter 307 with the CR adapter thread 310, the seating edge 307c of the CR adapter 307 may fit securely into the seating groove 311c of the snap cap engaging element 311, further securing the CR adapter 307, as well as any attached elements of a CR hex cap 301, securely to the wheel 302.

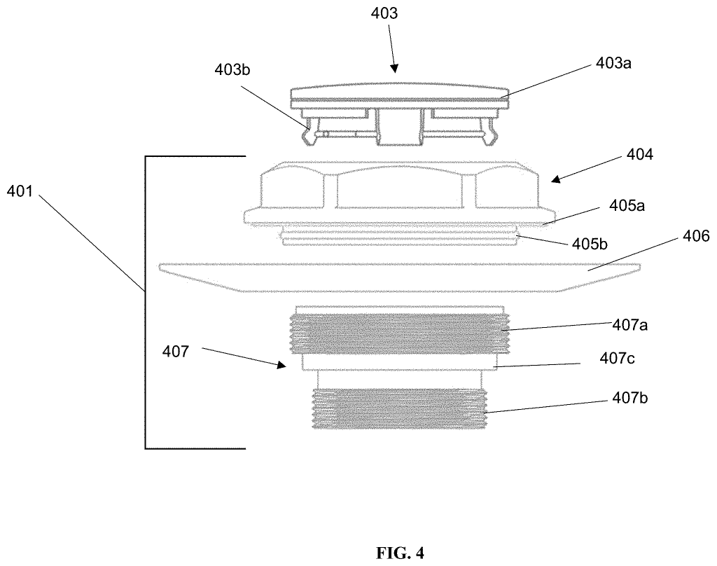

FIG. 4 illustrates the exploded view of CR hex cap 401 having an acrylic ESR hex snap cap 403, according to an aspect. Through utilization of a CR hex cap 401 within a wheel (not shown), an ESR hex snap cap 403 may be provided as a part of a said wheel. The ESR hex snap cap 403 may be made of a suitable material, such as acrylic, metal or another material that achieves the aesthetic and durability requirements of the application. The CR hex cap 401 may be configured to accept an ESR hex snap cap 403, while the aforementioned snap cap engaging element (not shown) of the center bore profile (not shown) may be configured to accept an ESR snap cap. Through the inclusion of both a snap cap engaging element and a CR adapter thread (not shown) on the center bore profile, a wheel may be configured to hold either an ESR hex snap cap 403 with a hex cap 404 or an ESR snap cap through selective usage of the herein disclosed CR hex cap 401. This will allow consumers to be able to select wheel center caps based solely upon the merits of said wheel center cap, and without having to give consideration to which type of wheel center cap is compatible with their wheel.

Certain elements of the disclosed wheel may be modified while still allowing for the attachment of a hex cap 404 to a wheel. For example, the CR hex cap 401 may be provided without the upper gaskets (not shown), lower gasket 405b or the lug cover 406, while also omitting the upper gasket retainer slots (not shown) and lower gasket retainer slots (not shown) from the hex cap 404. Such a simplified CR hex cap 401 may be utilized with an accordingly simplified wheel, such that the wheel has a center bore profile with the disclosed CR adapter thread and snap cap engaging element but lacks a lug cover seat. This combination of the simplified wheel with the simplified CR hex cap 401 may achieve the same goal of providing a wheel that may accept a snap cap or a hex cap 404, but without the utilization of elements related to the lug cover. An embodiment of the disclosed wheel may implement a combined version of the hex cap 404 and the CR adapter 407, such that the hex cap 404 and the CR adapter 407 are formed into a singular, monolithic structure that is configured to engage with CR adapter thread while simultaneously securing a hex snap cap 403. Additionally, the disclosed wheel may be provided without a hex cap 404, such that an alternative type of threaded ESR wheel center cap that is configured to engage with the provided upper thread 407a of the CR adapter 407 may be utilized. Such an alternative type of threaded wheel center cap may be provided with the same internally disposed thread as the hex cap 404 but may not retain the hex shaped characteristics of the disclosed hex cap 404, such as an octagonally shaped wheel center cap having the same internally disposed thread as the disclosed hex cap 404.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A wheel comprising:
a hub portion of the wheel, the hub portion disposed in a center of the wheel;
a center bore disposed at the center of the wheel and disposed within a perimeter of the hub portion;
a center bore perimeter wall disposed around a perimeter of the center bore;
a center bore profile nested within the center bore perimeter wall, the center bore profile comprising:
a wheel threaded portion configured to engage with a lower thread of an adapter; and
a snap cap engaging element configured to secure a snap cap, the snap cap engaging element comprising a seating groove, a securing ridge disposed below the seating groove and a clip slot disposed below the securing ridge;
an adapter comprising:
an upper thread;
a lower thread configured to engage with the wheel threaded portion; and
a seating edge disposed between the upper thread and the lower thread, wherein the seating edge is configured to fit securely within the seating groove upon engagement of the lower thread with the wheel threaded portion; and
a hex cap comprising:
a hex cap body;
a snap cap slot disposed within the hex cap body;
a hex snap securing ridge disposed within the snap cap slot; and
a hex cap thread disposed within the hex cap body, the hex cap thread being configured to engage with the upper thread of the adapter.

2. The wheel of claim 1, further comprising a hex snap cap having a hex cap body and one or more hex snap clips on the hex cap body, wherein the hex snap cap is configured to attach to the hex cap.

3. The wheel of claim 2, wherein the hex snap cap is configured to attach to the hex cap through insertion of each hex snap clip through the hex snap securing ridge, such that each hex snap clip is secured below the hex snap securing ridge and the hex cap body is secured within the snap cap slot.

4. The wheel of claim 1, further comprising a lug cover configured to be secured to the hex cap body, wherein the lug cover is configured to be disposed within a lug cover seat, the lug cover seat being disposed on the center of the wheel and around the perimeter of the hub portion.

5. The wheel of claim 4, the hex cap further comprising a lower gasket retainer slot disposed within the hex cap body.

6. The wheel of claim 5, further comprising a lower gasket configured to fit within the lower gasket retainer slot.

7. The wheel of claim 6, the hex cap further comprising two upper gasket retainer slots disposed within the hex cap body, wherein each upper gasket retainer slot of the two upper gasket retainer slots has a different diameter, is concentric with the other upper gasket retainer slot, and is disposed above the lower gasket retainer slot.

8. The wheel of claim 7, further comprising two upper gaskets, each upper gasket of the two upper gaskets being configured to fit within a different upper gasket retainer slot.

9. The wheel of claim 8, wherein the lug cover is configured to be disposed below the two upper gaskets and above the lower gasket, such that the lug cover is secured to the hex cap body as a result of the upper gaskets securing the lug cover from above and the lower gasket and lug cover seat securing the lug cover from below.

10. A wheel comprising:
a hub portion of the wheel, the hub portion disposed in a center of the wheel;
a center bore disposed at the center of the wheel and disposed within a perimeter of the hub portion;
a center bore perimeter wall disposed around a perimeter of the center bore;
a center bore profile nested within the center bore perimeter wall, the center bore profile comprising:
a wheel threaded portion configured to engage with a lower thread of an adapter;
a snap cap engaging element configured to secure a snap cap, the snap cap engaging element comprising a seating groove, a securing ridge disposed below the seating groove and a clip slot disposed below the securing ridge; and
an adapter comprising:
an upper thread;
a lower thread configured to engage with the wheel threaded portion; and
a seating edge disposed between the upper thread and the lower thread, wherein the seating edge is configured to fit securely within the seating groove upon engagement of the lower thread with the wheel threaded portion.

11. The wheel of claim 10, wherein the upper thread is configured to engage with a threaded ESR wheel center cap.

12. The wheel of claim 10, wherein the snap cap engaging element is disposed above the wheel threaded portion

13. A wheel comprising:
a hub portion of the wheel, the hub portion disposed in a center of the wheel;
a center bore disposed at the center of the wheel and disposed within a perimeter of the hub portion;
a center bore perimeter wall disposed around a perimeter of the center bore; and
a center bore profile nested within the center bore perimeter wall, the center bore profile comprising:
a wheel threaded portion configured to engage with a lower thread of an adapter; and
a snap cap engaging element configured to secure a snap cap, the snap cap engaging element comprising a seating groove, a securing ridge disposed below the seating groove and a clip slot disposed below the securing ridge.

14. The wheel of claim 13, further comprising a snap cap, the snap cap having a snap cap body and one or more snap cap clips on the snap cap body, wherein the snap cap is configured to attach to the snap cap engaging element.

15. The wheel of claim 14, wherein the snap cap is configured to attach to the snap cap engaging element through insertion of each snap cap clip through the securing ridge, such that each snap cap clip is secured within the clip slot and the snap cap body is secured within the seating groove.

16. The wheel of claim 13, wherein the snap cap engaging element is disposed above the wheel threaded portion.
